(19) United States
(12) Patent Application Publication
(10) Pub. No.: US 2012/0051432 A1
(43) Pub. Date: Mar. 1, 2012

(54) METHOD AND APPARATUS FOR A VIDEO CODEC WITH LOW COMPLEXITY ENCODING

(75) Inventors: Felix Carlos Fernandes, Plano, TX (US); Muhammad Salman Asif, Atlanta, GA (US)

(73) Assignee: Samsung Electronics Co., Ltd, Suwon-si (KR)

(21) Appl. No.: 13/217,100

(22) Filed: Aug. 24, 2011

Related U.S. Application Data
(60) Provisional application No. 61/377,360, filed on Aug. 26, 2010.

(51) Int. Cl. H04N 7/26

(52) U.S. Cl. 375/240.16; 375/240.01; 375/240.25; 375/E07.026; 375/E07.027; 375/E07.125

(57) ABSTRACT

A method and apparatus encode and decode a video that has been encoded with minimal computations. A first plurality of random measurements is taken for a first frame at an encoder. A subsequent plurality of random measurements is taken for each subsequent frame at the encoder such that the first plurality of random measurements is greater than each subsequent plurality of random measurements. Each plurality of random measurements is encoded into a bitstream. The encoded bitstream, which includes a current input frame, is received at a decoder. A sparse recovery is performed on the current input frame to generate an initial version of a currently reconstructed frame based on the current input frame. At least one subsequent version of the currently reconstructed frame is generated based on a last version of the currently reconstructed frame, such that each subsequent version has a higher image quality than the last version.

### CROSS-REFERENCE TO RELATED APPLICATION(S) AND CLAIM OF PRIORITY

The present application is related to U.S. Provisional Patent. Application No. 61/377,360, filed Aug. 26, 2010, entitled “LOW COMPLEXITY VIDEO ENCODER (LoCVE)”. Provisional Patent Application No. 61/377,360 is assigned to the assignee of the present application and is hereby incorporated by reference into the present application as if fully set forth herein. The present application hereby claims priority under 35 U.S.C. §119(e) to U.S. Provisional Patent Application No. 61/377,360.

### TECHNICAL FIELD OF THE INVENTION

The present application relates generally to video encoding/decoding (codec) scheme and, more specifically, to a method and apparatus for a video codec scheme that supports decoding video that has been encoded with minimal computations.

### BACKGROUND OF THE INVENTION

Current video coding technology has developed assuming that a high-complexity encoder in a broadcast tower would support millions of low-complexity decoders in receiving devices. However, with the proliferation of inexpensive camcorders and cellphones, User-Generated-Content (UGC) will become commonplace and there is a need for low-complexity video-encoding technology that can be deployed in these low-cost devices. FIG. 1 shows compression ratios attainable by standard video coders as well as typical power consumption. Because encoder complexity is proportional to power consumption, we observe that high compression ratios are achieved at the cost of high power consumption. To enable the widespread creation of UGC by inexpensive devices, there is a need for low-complexity video encoders that use minimal computations to achieve moderate compression ratios and low power consumption.

U.S. Pat. No. 7,233,269 B1 (Chen), US 2009/0225830 (He), US 2009/0122868 A1 (Chen) and US 2009/0323798 A1 (He) describe technology that use Wyner-Ziv theory to shift the computationally complex motion-estimation block from the encoder to the decoder, thus reducing encoder complexity. Although these inventions reduce encoder technology compared to the standardized codecs, their encoders still have relatively high complexity because they require transform-domain processing and quantization. Furthermore, Wyner-Ziv encoders usually require a feedback channel from the decoder to the encoder to determine the correct encoding rate. Such feedback channels are impractical for UGC creation. To avoid feedback channels, some Wyner-Ziv encoders US 2009/0323798 A1 (He) use rate-estimation blocks. Unfortunately, these blocks also increase encoder complexity.

US 2009/0196513 A1 (Tian) and US 2010/0080473 A1 (Han) exploit compressive sampling to improve coding performance of standardized encoders. Although compressive sampling theoretically enables low-complexity encoding of certain data sources, these inventions attempt to augment standardized encoders with a compressive-sampling block, to increase compression ratios. Therefore these implementations still have high complexity.

In “Compressive Coded Aperture Imaging,” SPIE Electronic Imaging, 2009 (Marcia, et al.), compressive sampling is used to implement a low-complexity video encoder in which a hardware component directly converts video frames into a compressed set of measurements. To reconstruct the video frames, the decoder solves an optimization problem. However, because the decoder does not explicitly account for the motion of objects between video frames, this method achieves low compression ratios.

In “A Multiscale Framework for Compressive Sensing of Video,” Picture Coding Symposium (PCS 2009), Chicago, 2009, (Park et al.), compressive sampling is used for video encoding. This implementation does model object-motion between video frames and hence it provides higher compression ratios than Marcia et al. However, the implementation requires the encoder to compute the wavelet transform of each video frame. Hence this implementation has relatively high complexity.

There exists a need for a low-complexity video encoder in which the encoder performs minimal computations. To achieve moderate compression ratios, the corresponding decoder must account for inter frame object motion. Additionally, the encoder and decoder must function independently, without a feedback channel.

### SUMMARY OF THE INVENTION

A method for encoding a video is provided. A first plurality of random measurements is taken for a first frame at an encoder. A subsequent plurality of random measurements is taken for each subsequent frame at the encoder such that the first plurality of random measurements is greater than each subsequent plurality of random measurements. Each plurality of random measurements is encoded into a bitstream.

An apparatus for encoding video is provided. The apparatus includes a compressive sampling (CS) unit and an entropy coder. The CS unit takes a first plurality of random measurements for a first frame, and takes a subsequent plurality of random measurements for each subsequent frame at the encoder. The first plurality of random measurements is greater than each subsequent plurality of random measurements. The entropy coder encodes each plurality of random measurements into a bitstream.

A method for decoding video is provided. An encoded bitstream, which includes a current input frame, is received at a decoder. A sparse recovery is performed on the current input frame to generate an initial version of a currently reconstructed frame based on the current input frame. At least one subsequent version of the currently reconstructed frame is generated based on a last version of the currently reconstructed frame. Each subsequent version of the currently reconstructed frame has a higher image quality than the last version of the currently reconstructed frame.

An apparatus for decoding video is provided. The apparatus includes a decoder and a controller. The decoder receives an encoded bitstream that includes a current input frame, generates an initial version of a currently reconstructed frame based on the current input frame, and generates at least one subsequent version of the currently reconstructed frame based on a last version of the currently reconstructed frame. The subsequent version of the currently reconstructed frame has a higher quality image than the last version of the currently reconstructed frame. The controller determines how many subsequent versions of the currently reconstructed frames are to be generated. The decoder includes a sparse recovery unit that generates the initial version of the currently reconstructed frame by performing a sparse recovery on the current input frame.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates approximate operating points in terms of power consumption and compression ratio for various video codecs according to principles of the disclosure;

FIG. 2 illustrates a system level diagram according to the principles of the present disclosure;

FIG. 3 illustrates a block diagram of a general compressive sampling (CS) encoder for images or video according to an embodiment of the present disclosure;

FIG. 4 illustrates a block diagram of a CS encoder for predictive decoding of video frames according to an embodiment of the present disclosure;

FIGS. 5A-5C illustrate traditional encoding techniques that may be integrated with CS according to embodiments of the present disclosure;

FIG. 6 illustrates a block diagram of a general CS decoder for images or video according to an embodiment of the present disclosure;

FIG. 7 illustrates a block diagram for multi-resolution decoding according to an embodiment of the present disclosure;

FIG. 8 illustrates a flow diagram for predictive, multi-resolution decoding according to an embodiment of the present disclosure;

FIG. 9 illustrates a flow diagram for a predictive, sparse-residual recovery process performed in a CS decoder according to an embodiment of the present disclosure;

FIG. 10 illustrates a flow diagram for a predictive, multi-resolution, sparse-residual recovery process performed in a CS decoder according to an embodiment of the present disclosure;

FIG. 11 illustrates a process performed by an encoder that uses transform-domain measurements to reduce decoder complexity, according to an embodiment of the present disclosure; and

FIG. 12 illustrates a high-level block diagram of a CS decoder according to an embodiment of the present disclosure.

### DETAILED DESCRIPTION OF THE INVENTION

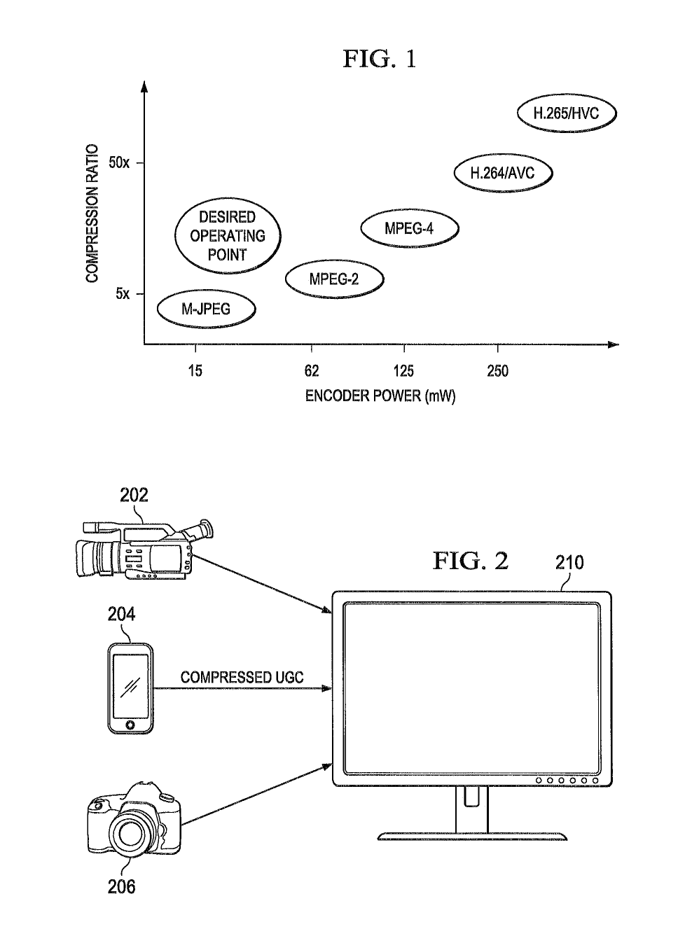

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged video encoder/decoder.

To achieve moderate compression ratios, the corresponding decoder must account for inter-frame object motion. Additionally, the encoder and decoder must function independently, without a feedback channel. Embodiments of the present disclosure operate at approximately the “Desired Operating Point” in FIG. 1 (note: the chart in FIG. 1 is not drawn to scale).

FIG. 2 illustrates a system level diagram according to the principles of the present disclosure. As shown, a low-power, low-complexity video encoder is implemented in a low-cost device such as a camcorder 202, cell phone 204, or digital camera 206. However, these are merely examples as any low-power, low-complexity video encoder may be used. This low-complexity encoder scheme allows inexpensive devices to capture high-resolution UGC video directly in a compressed format that may be downloaded to a powered device such as a high-definition television 210, a personal computer (not shown), or any device that is capable of decoding the compressed video format. The powered device has a decoder implementation that reconstructs a high-quality version of the UGC video from the compressed format.

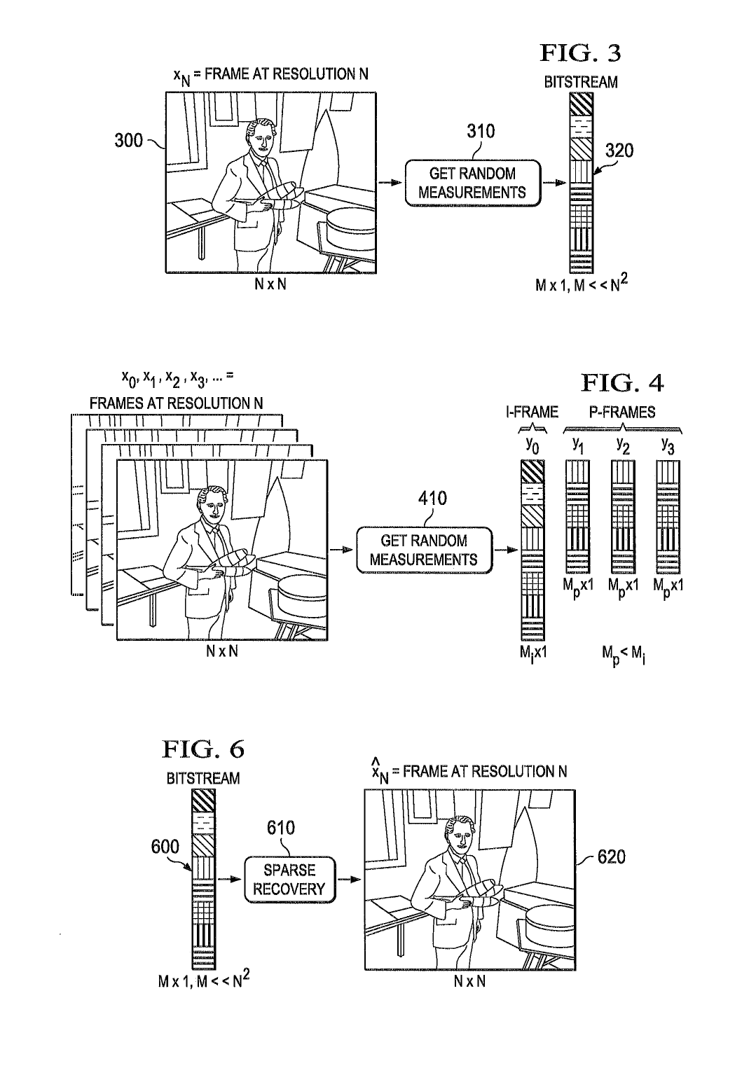

FIG. 3 illustrates a block diagram of a general compressive sampling (CS) encoder for images or video according to an embodiment of the present disclosure. The original image 300 may be a video frame that may be represented as an N×N matrix, where N denotes the resolution. As the original image 300 belongs to a human-viewable image that some form of structure (relatively smooth areas and edges), it can be assumed that the vector x_{N} of the original image 300 enjoys sparse representation in some basis, e.g. wavelet transformation. Therefore, a small number of transform coefficients can represent the image without much perceptual loss. CS theory states that the N² pixels can be compressed into a vector y of length M (i.e. bitstream 320), where M<<N², and that the vector y can still be used to recover the original image 300. As shown, the original image 300 may be compressed to the bitstream 320 using a compressive sampling (CS) device 310.

In compressive sampling, the video frame 300 having N×N pixels may be converted to an N²×1 vector x_{N} that is sampled using a random sensing matrix A (i.e. measurement matrix) having a size of M×N² (i.e. matrix A has N² elements in each row and M columns where M is smaller than N²). This may be mathematically represented as a matrix multiplication of the random sensing matrix A and vector x_{N} which produces an M×1 vector y, according to Equation 1 below:

y=Ax_{N} [Eqn. 1]

The resulting product is the bitstream 320 which is an M×1 vector y. As M (number of elements in the bitstream 320) is less than N² (number of elements in vector x_{N} of the original image 300), compression is achieved through a very simple process. It is noted that the above process is a mathematical description of the CS process, which is generally performed in the CS device 310. Some examples of devices that enable CS include a digital micromirror device (DMD) of a single pixel encoder, Fourier optics in a Fourier domain random convolution decoder, a Complementary Metal-Oxide-Semiconductor (CMOS) in a spatial-domain random convolution encoder, vibrating coded-aperture mask of a coded-aperture encoder, a noiselet-basis encoder, and any other device that supports the taking of random measurements from images.

FIG. 4 illustrates a block diagram of a CS encoder for predictive decoding of video frames according to an embodiment of the present disclosure. In predictive decoding, a reconstructed frame is used to approximate and reconstruct the following frame. As shown, four of the original frames of the video, denoted by x₀, x₁, x₂, and x₃, are processed in an encoder through a CS device 410 to generate compressed bitstreams denoted by y₀, y₁, y₂, and y₃, respectively. That is, x₀, which is assumed to be the first frame of the video sequence, is processed by the CS device 410 to produce the first compressed bitstream y₀ having M₁ elements. The subsequent frames x₁, x₂, and x₃ are processed by the CS device 410 to produce the subsequent corresponding bitstreams y₁, y₂ and y₃, each having Mₚ elements.

It is noted that Mₚ<Mᵢ, meaning that less compression was used for x₀ than the subsequent frames. In other words, the first video frame is encoded in a set with more measurements, while the subsequent video frames are encoded with fewer measurements. This is because during the decoding process, the first bitstream y₀ does not have a reconstructed previous video frame that can be used as a reference for generating the reconstructed frame \hat{x}₀, which has been approximated based on y₀ to reconstruct frame x₀. That is, frame x₀ is reconstructed independently based on the bitstream y₀. In contrast, frame x₁ can be reconstructed based on the bitstream y₁ and the reconstructed previous frame \hat{x}₀ to generate the reconstructed frame \hat{x}₁. Similarly, frame x₂ may be reconstructed based on the bitstream y₂ and the reconstructed previous frame \hat{x}₁ to generate the reconstructed frame \hat{x}₂, and frame x₃ may be reconstructed based on the bitstream y3 and the reconstructed previous frame \hat{x}₂ to generate the reconstructed frame \hat{x}₃, and so forth. As such, the bitstream y₀ corresponds to the I-Frame, the first reference frame which is to be decoded independently by a decoder. Bitstreams y₁, y₂, and y₃ correspond to P-Frames, each of which is to be predicted from a reference frame (i.e. the reconstructed previous frame) by the decoder. According to an embodiment, motion information from the first frame (x₀) may be used to improve estimates of the subsequent frames.

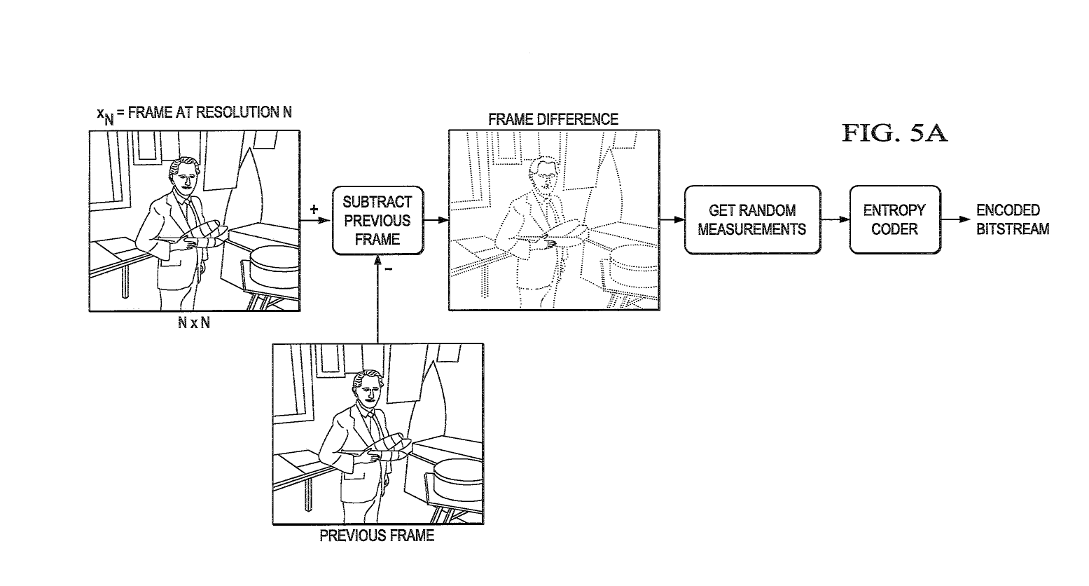

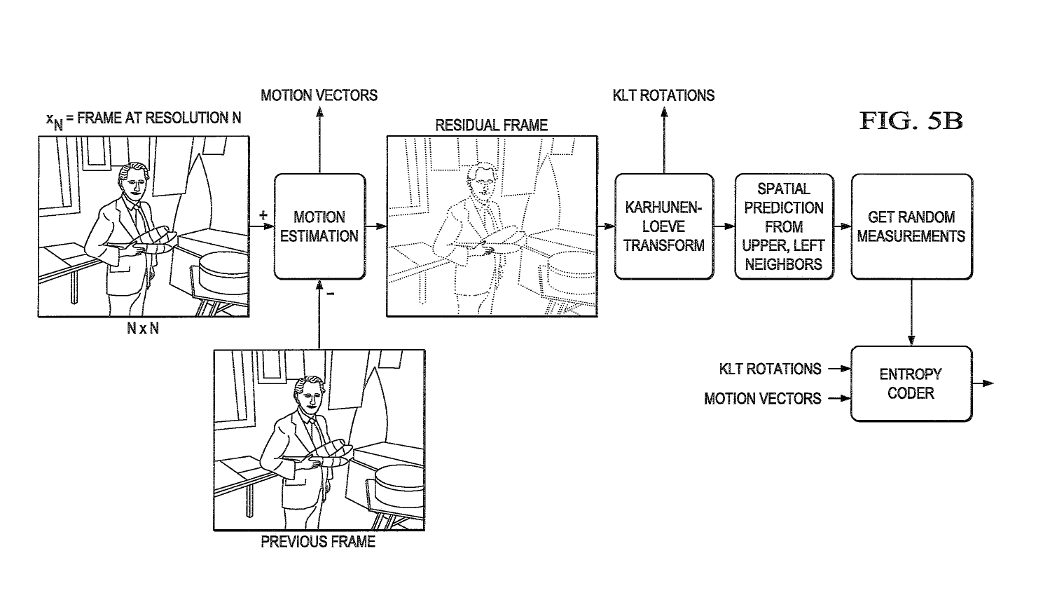

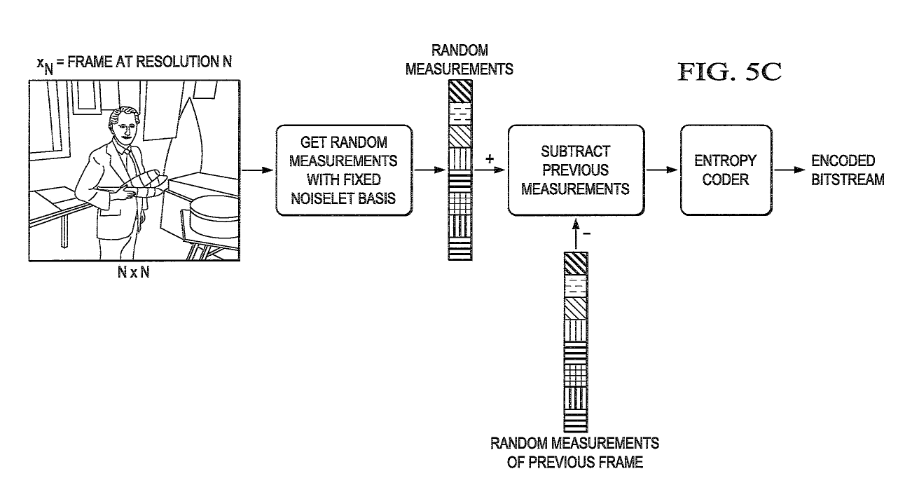

There are several ways to improve the CS encoding process. FIGS. 5A-5C illustrate traditional encoding techniques that may be integrated with CS according to embodiments of the present disclosure. FIG. 5A illustrates a process performed by an encoder integrating lossless coding prior to taking random measurements of an image, according to an embodiment of the present disclosure. As shown, when encoding a current frame, a difference vector is determined by subtracting a previous frame vector from the current frame vector. Random measurements are then taken from the difference vector (i.e. the random sensing matrix A is multiplied by the difference vector), and then processed through entropy coding to generate the encoded bitstream. Random measurements of the frame difference have lower entropy than random measurements of a frame. Therefore, entropy coding may increase compression ratio.

FIG. 5B illustrates a process performed in an encoder integrating motion estimation, color-spatial-temporal decorrelation and entropy coding prior to taking random measurements, according to an embodiment of the present disclosure. As shown, when encoding a current frame, motion is estimated based on a difference between the current frame vector and the previous frame vector to determine motion vectors and a residual frame vector to achieve temporal decorrelation. The residual frame vector, which is the difference between the current frame and the previous frame after compensating for motion between the frames, is processed through a decorrelating transform, such as the discrete cosine transform (DCT) or other wavelet transforms. The transformed residual vector is then used for spatial prediction. According to an embodiment, the residual frame vector is processed through a Karhunen Loeve Transform (KLT) for color decorrelation and to determine KLT rotations, and the KLT-rotated residual frame is used in upper/left spatial prediction (i.e. spatial prediction from upper, left neighbors) for spatial decorrelation The random measurements are then taken for entropy coding, along with the KLT rotations and motion vectors that were determined during the processing of the current frame, to generate the encoded bitstream. Random measurements of the decorrelated frame have lower entropy than random measurements taken from the actual, current frame. Therefore, entropy coding will increase compression ratio.

FIG. 5C illustrates a process performed by an encoder integrating temporal decorrelation and entropy coding after taking random measurements, according to an embodiment of the present disclosure. As shown, random measurements are taken using a fixed measurement matrix (noiselets). With a fixed measurement matrix, random measurements of consecutive frames are highly correlated. As such, a difference is calculated between the random measurements taken from the current frame and the random measurements taken from the previous frame. The random measurement differences are then processed through an entropy coder to generate the encoded bitstream. As random measurement differences also have lower entropy than random measurements taken from the actual frame, entropy coding the random-measurement differences will also increase compression ratio.

As previously discussed, different types of encoding techniques such as single-pixel encoding, Fourier-domain random convolution encoding, spatial-domain random convolution encoding, coded-aperture encoding, and noiselet-basis encoding may be used in various embodiments of the present disclosure. In some situations, one or more types of encoding techniques may be available during an encoding process. According to an embodiment, the encoder may determine the optimal random measurements and measurement technique for a given video.

FIG. 6 illustrates a block diagram of a general CS decoder for images or video according to an embodiment of the present disclosure. In general, the decoder receives the bitstream 600 (which is similar to bitstream 320) which includes the compressed video format. The sparse recovery block 610 is used to estimate the decoded image 620 based on the bitstream 600 to recover the originally encoded image. For example, assuming the vector y_{M} of bitstream 610 containing M elements carries the encoded format of the vector x_{N} of original image 300 that had a resolution N, the sparse recovery block solves a sparse recovery problem to estimate \hat{x}_{N} based on the bitstream 610 according to constrained Equation 2a or unconstrained Equation 2b below:

$$\begin{matrix}\begin{matrix}min \\ \hat{x}\end{matrix} {‖ {Ψ}^{T} \hat{x} ‖}_{1} subject to y = A \hat{x} \\ or & [ Eqn . 2 a ] \\ \begin{matrix}min \\ \hat{x}\end{matrix} {‖ A \hat{x} - y ‖}_{2} + α {‖ {Ψ}^{T} \hat{x} ‖}_{1} & [ Eqn . 2 b ]\end{matrix}$$

where Ψ denotes any suitable sparse-representation basis, \hat{x} denotes the estimate of the vector x_{N} of the original image 300, y denotes the vector y_{M} of the bitstream 600, and A denotes the random sensing matrix that was used to generate the bitstream 600. In Equation 2a, Ψ and y are known and used to determine a best estimate of \hat{x} that corresponds to y. A different Ψ may be used for according to the type of video to optimize decoding. In Equation 2b, α controls the tradeoff between the sparsity term ∥Ψ^{T}\hat{x}∥₁ and the data consistency term ∥A\hat{x}−y∥₂. α may be selected based on many different factors including noise, signal structure, matrix values, and so forth. These optimization problems may be referred to as sparse solvers which accept A, Ψ, and y as input and give out the signal estimate \hat{x}. Equation 2a and Equation 2b may be solved via a convex solver or approximated with a greedy algorithm.

The equality constrained problem of Equation 2a can be made equivalent to the unconstrained form of Equation 2b, but in a very loose sense. Choosing a very small value of α would result in both equations 2a and 2b giving solutions that are very close to each other. The equality constrained problem (also called Basis pursuit) is usually used when there is substantially no noise in the measurements and the underlying signal enjoys a very sparse representation. However, if there is some noise in the measurements, or for whatever reason the signal estimate does not match the measurements exactly (which will be the case if only a low-resolution image is estimated from the measurements of a full-resolution image), then the equality constraint Ax_{N}=y may be relaxed with something similar to ∥A\hat{x}−y∥₂<=ε for some small value of ε (also called Basis pursuit de-noising). The unconstrained form in the present disclosure is equivalent to the basis pursuit de-noising. In short, the relaxed form is used when measurement constraints cannot be satisfied and constrained otherwise.

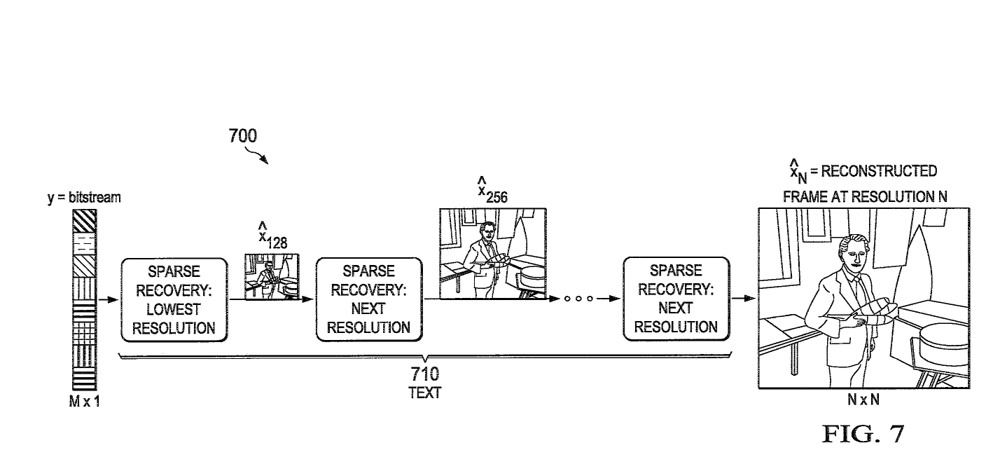

FIG. 7 illustrates a flow diagram for a multi-resolution decoding process performed in a CS decoder according to an embodiment of the present disclosure. Process 700, which reconstructs frames, independently, may be used to recover all video frames, including both I-frames (i.e. the first frame) and P-frames (i.e. subsequent frames that have fewer measurements), according the embodiment of the present disclosure. In process 700, the decoder receives an input vector y (which is similar to bitstream 320) which includes the compressed video format of a video frame. Thereafter, sparse recovery block 710 processes the input vector through a series of estimations (e.g. an iterative process) to recover an approximation of the original image. As shown, each subsequent estimation performs a sparse recovery to improve the resolution of the estimated image \hat{x}_{N}. The lowest resolution wavelets are determined according to Equation 3 below:

$$\begin{matrix}min \\ \hat{x}\end{matrix} {‖ A \hat{x} - y ‖}_{2} + {α}_{0} {‖ {Ψ}_{0}^{T} \hat{x} ‖}_{1} \qquad [ Eqn . 3 ]$$

Where Ψ₀ denotes the wavelet basis restricted to resolution ‘0’ wavelets, which are wavelets corresponding to the lowest defined resolution. The subsequent resolution wavelets can be estimated according to Equation 4 below:

$$\begin{matrix}min \\ \hat{x}\end{matrix} {‖ A \hat{x} - y ‖}_{2} + {α}_{k} {‖ {Ψ}_{k}^{T} \hat{x} ‖}_{1} \qquad [ Eqn . 4 ]$$

where Ψₖ denotes the wavelet basis restricted to the resolution-k wavelets, for k=1, 2, 3, . . . that corresponds to each subsequent estimation, and αₖ may change with the k wavelets. Because minimization is over basis subsets, the recovery is more robust. Multi-resolution implies spatial and complexity scalability. That is, the number of iterations may be set in the decoder by a user or preconfigured. Alternatively, decoding may be halted at an intermediate resolution in low-complexity devices that do not support high resolution. It is noted that Equation 4 does not recover signal approximation at any scale exactly. Rather, the number of iterations may be used to reach a particular level of approximation/resolution. The sparse recovery block 710 may perform sparse recovery in a feedback loop such that the estimated vector \hat{x}_{N} from a current iteration may be used as an input, along with the next Ψₖ, for the next iteration in the loop. A controller (not shown) may determine the number of iterations. Furthermore, the multi-resolution approach can exploit motion information efficiently. According to another embodiment the constrained forms of Equations 3 and 4 may be used.

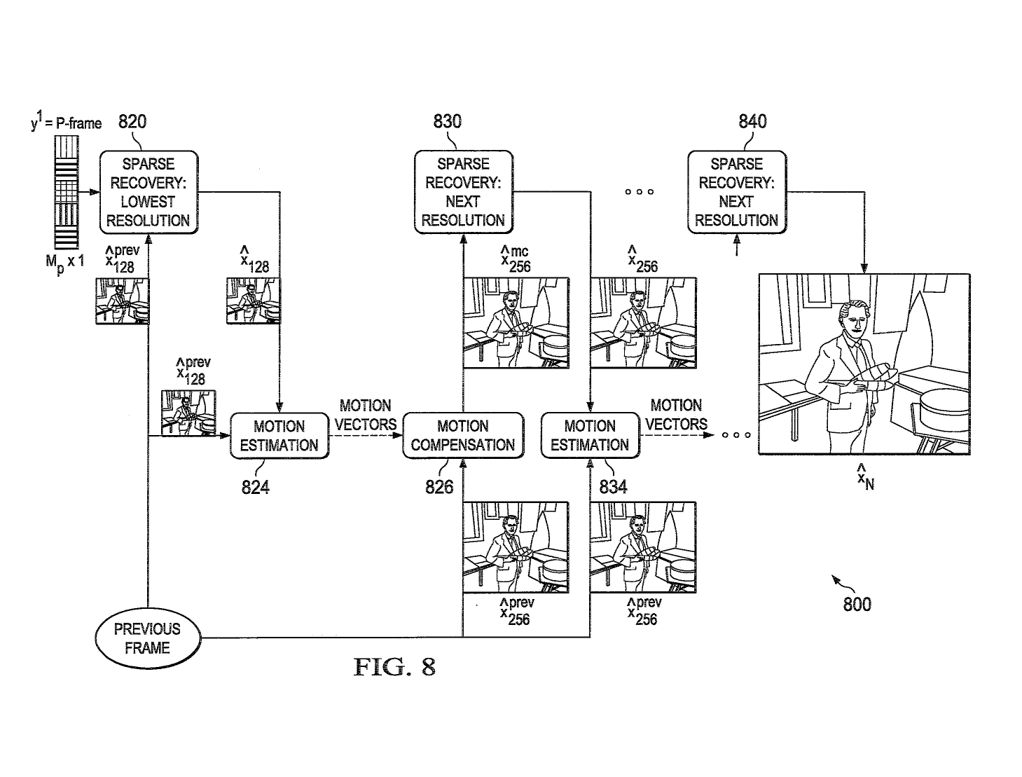

FIG. 8 illustrates a flow diagram of a portion of a predictive, multi-resolution process performed in a CS decoder according to an embodiment of the present disclosure. The predictive, multi-resolution process 800, which iteratively reconstructs a current frame based on a previously reconstructed frame, may be used to reconstruct subsequent frames (i.e. P-frames) of a video. To improve stability and to efficiently exploit motion information, a multi-scale approach is used. In essence, process 800 may also be performed as a feedback loop (i.e. multiple iterations) for each input vector y_{index} where index denotes the sequence index of the current video frame.

In block 820, \hat{x}₁₂₈, a low-resolution version of the image (i.e. any size image that does not have confidence in wavelet coefficients on finer scales beyond the 128×128 resolution), is reconstructed from the input vector y_{index} (i.e. the input bitstream) by solving an optimization problem that determines the sparsest lowest-resolution wavelets which agree with the measurements according to Equation 4. According to an embodiment, a previously reconstructed frame at the lowest resolution (e.g. \hat{x}₁₂₈^{prev}) may be used to initiate the optimization search for the lowest resolution version of the reconstructed frame (e.g. \hat{x}₁₂₈). When process 800 is performed as a feedback loop, block 820 may be construed as the operation for initializing the loop. That is, the lowest-resolution version of P-frame \hat{x}₁₂₈ is decoded without motion information.

According to an embodiment, Equation 3 and Equation 4 may be “warm-started”, using the estimate of the previous frame or lower resolution estimate of the current frame. This can help in expediting the iterative update and restricting the search space for the candidate solutions.

In block 824, motion is estimated against the lowest-resolution version of the previous, reconstructed frame (e.g. \hat{x}₁₂₈^{prev}) to determine motion vectors. According to an embodiment, various types of motion estimation may be used, such as phase-based motion estimation using complex wavelets, or optical flow, or block-based motion estimation, or mesh-based motion estimation. In the present disclosure any of these or other motion-estimation techniques may be used wherever the term “motion estimation” occurs. In block 826, the resultant motion vectors are used to motion compensate a next higher resolution version of the previous frame (e.g. \hat{x}₂₅₆^{prev}), and this motion-compensated frame (e.g. \hat{x}₂₅₆^{mc}) initiates the optimization search for the next higher-resolution version of the reconstructed frame. According to an embodiment, however, the motion compensation may be performed on image estimates at full resolution (i.e. final reconstructed version of the previous frame). As shown in blocks 830, 834, and 840, these operations may be repeated until the highest-resolution version of the frame consistent with the measurements is recovered (i.e. \hat{x}_{N}). As already mentioned, the number of iterations may be configured by a user, predetermined, adjusted at run-time, and so forth. When the current frame is reconstructed, process 800 may then be performed, using the versions of the recovered frame \hat{x}_{N} at the various resolutions may be used as the new reference frames, to recover the next incoming frame. As such, the versions of the reference frames that support various resolutions may be stored in memory or a set of registers. When performed as a feedback loop, the operations described in blocks 824, 826, and 830 may be looped such that the output of block 830 and the corresponding resolution version of the previous frame may be used as the inputs for the next iteration in the loop. A controller (not shown) may control the feedback loop and determine the number of iterations.

It is noted that although the intermediate versions of the reconstructed frame (e.g. \hat{x}₁₂₈) imply a resolution of 128×128, this is merely used in the present disclosure as an example and is not intended to limit the scope of the present disclosure. In fact, \hat{x}₁₂₈ also does not necessarily refer to a resolution or the actual size of the image. Instead, the \hat{x}₁₂₈ notation should be regarded as any image for which there is insufficient confidence in wavelet coefficients on finer scales beyond the specified resolution level (here, 128×128). According to an embodiment, measurements may be taken at full resolution/size (i.e. number of pixels). As such, each intermediate version of the reconstructed image may be construed as having full size (i.e. number of pixels) in the spatial domain; the term “resolution” denotes how many scales of the wavelets were used to reconstruct the image. This similarly applies to references to versions of the reconstructed frame (e.g. lowest resolution version, low-resolution version, high-resolution version, next higher resolution version, previous lower resolution version, and such). Moreover, this applies to all embodiments of the present disclosure.

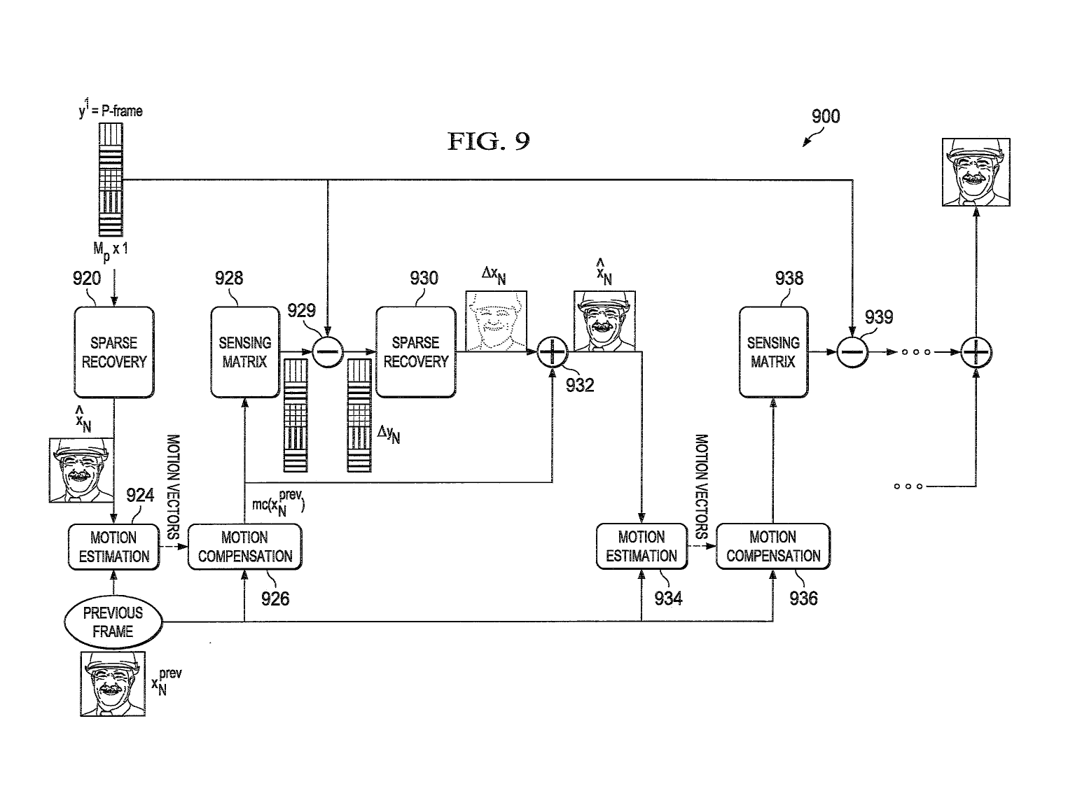

FIG. 9 illustrates a flow diagram of a portion of a predictive, sparse-residual recovery process performed in a CS decoder according to an embodiment of the present disclosure. The predictive, sparse-residual recovery process 900, which also iteratively reconstructs a current frame based on a previously reconstructed frame, may be used to reconstruct subsequent frames (i.e. P-frames) of a video. Process 900 exploits inter-frame temporal correlation by modeling an inter-frame motion-compensated difference as a sparse vector in some known basis. The decoding procedure recursively updates both the motion estimate and the frame estimate. In essence, process 900 may also be performed as a feedback loop (i.e. multiple iterations) for each input vector y_{index}, where index denotes the sequence index of the current video frame.

In block 920, a sparse recovery is performed from the input vector y_{index} by solving the sparse recovery problem to estimate \hat{x}_{N} according to Equation 2. When process 900 is performed as a feedback loop, block 920 may be construed as the operation for initializing the loop.

In block 924, motion is estimated against the previous reconstructed frame to determine motion vectors. According to an embodiment, the motion vectors are estimated using complex-wavelet phase-based motion estimation, or traditional block-, or mesh-based motion estimation, or optical flow. Alternatively, the CS decoder may use any elaborate motion estimation scheme, as it does not incur any cost in terms of communication overhead like it does in conventional coders. In block 926, the motion vectors are used to compute a motion compensated frame mc(x_{N}^{prev}) from the reference frame (i.e. the previous reconstructed frame x_{N}^{prev}).

In block 928, a sensing matrix A is applied to the motion compensated frame mc(x_{N}^{prev}). The operation is similar to multiplying the sensing matrix A with the motion compensated frame mc(x_{N}^{prev}) to get A(mc(x_{N}^{prev})). In block 929, Δy is calculated as the difference between the input vector y_{index} and A(mc(x_{N}^{prev})) (i.e. the output of block 928).

In block 930, Δy is used to estimate the motion compensated residual Δx by solving a sparse recovery problem according to Equation 5 below:

$$\begin{matrix}min \\ Δ x\end{matrix} {‖ {Ψ}^{T} Δ x ‖}_{1} subject to Δ y = A Δ x \qquad [ Eqn . 5 ]$$

Referring back to Equation 1, the following relationship may be derived according to Equation 6:

Δy=y_{index}−A(mc(x_{N}^{prev}))≡A(x_{index}−mc(x_{N}^{prev})) [Eqn. 6]

where x_{index} denotes the original image that was encoded at an encoder. According to Equation 7:

Δx=x_{index}−mc(x_{N}^{prev}) [Eqn. 7]

Therefore, in block 932, the new estimate for x_{index} may be calculated according to Equation 8:

\hat{x}_{index}=mc(x_{N}^{prev})+Δx [Eqn. 8]

where \hat{x}_{index} denotes the new \hat{x}_{N}. Blocks 934, 936, 938, and 939 perform substantially the same operations as blocks 924, 926, 928, and 929, with the difference being that the input vector is the new \hat{x}_{N}. In other words, the operations of blocks 924-930 may be repeated with each updated \hat{x}_{N} any number of times such that, with each subsequent iteration, the reconstruction of the original image is improved. The number of iterations may be preconfigured or adjusted. A controller (not shown) may determine the number of iterations. The last \hat{x}_{N} that is estimated may then be set as the reference frame (i.e. previous frame) by the decoder to reconstruct the next incoming video frame using process 900.

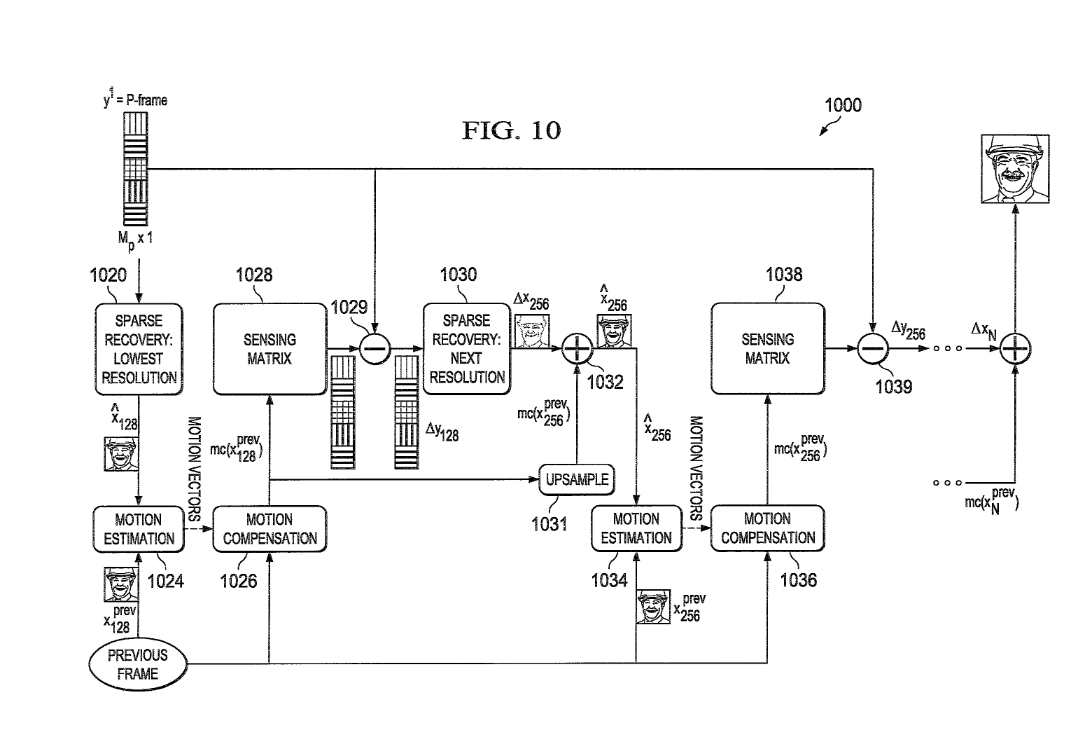

FIG. 10 illustrates a flow diagram of a portion of a predictive, multi-resolution, sparse-residual recovery process performed in a CS decoder according to an embodiment of the present disclosure. Process 1000 is a multi-scale approach of process 900. Similar to process 800 and process 900, process 1000 iteratively reconstructs a current frame based on previously reconstructed frame and may be used to reconstruct P-frames of an incoming video stream. Process 1000 may also be performed as a feedback loop for each input vector y_{index}, where index denotes the sequence index of the current video frame.

In block 1020, a low-resolution version of the image, is reconstructed from the input vector y_{index} (i.e. the input bitstream) by solving an optimization problem that determines the sparsest lowest-resolution wavelets which agree with the measurements according to Equation 4. When process 1000 is performed as a feedback loop, block 1020 may be construed as the operation for initializing the loop. That is, the lowest-resolution version of P-frame \hat{x}₁₂₈ is decoded without motion information.

In block 1024, motion is estimated against the lowest-resolution version of the previous, reconstructed frame (e.g. \hat{x}₁₂₈^{prev} to determine motion vectors. In block 1026, the motion vectors are used to compute a motion compensated frame mc(x₁₂₈^{prev}) the lowest-resolution version of the previous, reconstructed frame \hat{x}₁₂₈^{prev}.

In block 1028, a sensing matrix A is applied to the motion compensated frame mc(x₁₂₈^{prev}). The operation is similar to multiplying the sensing matrix A with the motion compensated frame mc(x₁₂₈^{prev}) to get A(mc(x₁₂₈^{prev})). As explained previously, this operation is well-defined because mc(x₁₂₈^{prev}) may be construed as having full-domain spatial size. In block 1029, Δy₁₂₈ is calculated as the difference between the input vector y_{index} and A(mc(x₁₂₈^{prev})) (i.e. the output of block 1028).

In block 1030, Δy₁₂₈ is used to estimate the motion compensated residual at a next higher resolution version (e.g. Δx₂₅₆) by solving a sparse recovery problem according to Equation 5. In block 1031, the motion compensated frame mc(x₁₂₈^{prev}) is also upsampled to the next higher resolution (e.g. mc(x₁₂₈^{prev})). In block 1032, the new estimate for \hat{x}₁₂₈ may be calculated according to Equation 8. As such, blocks 1024-1032 constitute one iteration for reconstructing the video frame.

Subsequent iterations (comprising the functions of blocks 1024-1032) reconstruct the images that support higher resolutions. A controller (not shown) may determine the number of iterations. As already discussed, the number of iterations may be configured by a user, predetermined, adjusted at run-time, and so forth. For example, in block 1031, the estimated image vector \hat{x}₁₂₈ is upsampled (i.e. the size of the vector is increased by interleaving zeros and then interpolation filtering, or by wavelet-domain upsampling) to create a new image vector that can support a higher resolution (e.g. \hat{x}₂₅₆). In an embodiment, a low-resolution image may be used for \hat{x}₂₅₆ to reduce buffering costs. In such an embodiment, the upsample 1031 creates the higher resolution \hat{x}₂₅₆ that is subsequently used by 1032 for motion estimation. However, as previously discussed, the higher resolution does not necessarily indicate an increase in the spatial size of the image but, rather, an increase in the number of scales of the wavelets that were used to reconstruct the image. According to an embodiment, another upsample block may be added before each sensing matrix such that measurements at the sensing matrix are taken at full resolution (i.e. number of pixels in the final image).

According to another embodiment, intermediate estimates may comprise full spatial size images that are reconstructed from wavelet approximations at different scales. According to yet another embodiment, in which buffering costs are not an issue, no upsampling blocks are required. In this embodiment, full resolution is maintained in all images, but the effective resolution is determined by the number of wavelet scales used for reconstruction. Therefore, for example, \hat{x}₂₅₆ would use one more wavelet scale than \hat{x}₁₂₈ although both these images would have the N×N pixels, where N is the maximum resolution and N may be larger than 256. Blocks 1034, 1036, 1038, and 1039 are substantially similar to blocks 1024, 1026, 1028, and 1029, respectively. Any number of iterations may be performed in a loop according to an embodiment until the highest-resolution version of the frame consistent with the measurements is recovered (i.e. \hat{x}_{N}).

When the current frame is reconstructed, the decoder may set the versions of the recovered frame \hat{x}_{N} at the various resolutions as the new reference frames to recover the next incoming frame using process 1000. As such, the versions of the reference frames at the various resolutions may be stored in memory or a set of registers. When performed as a feedback loop, the operations described in blocks 1024, 1026, 1028, 1029, 1030, and 1032 may be looped, with the estimated frame at each iteration being upsampled for the subsequent iteration, such that the output of block 1032 and the corresponding resolution version of the previous frame may be used as the inputs for the next iteration in the loop.

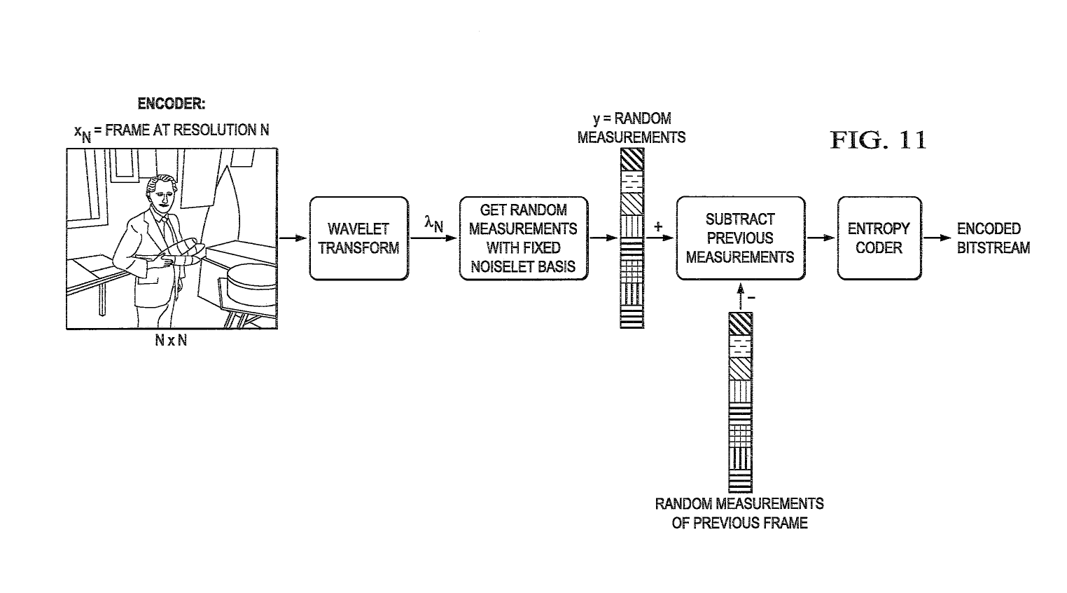

According to some embodiments, the encoding and decoding processes of the present disclosure may be performed in a transform domain. FIG. 11 illustrates a process performed by an encoder that uses wavelet-domain measurements to reduce decoder complexity, according to an embodiment of the present disclosure. As shown, a wavelet transform is performed on a current frame vector to generate a wavelet frame vector, from which random measurements are taken using a fixed measurement matrix (noiselets). A difference is then calculated between the random measurements taken from the current wavelet frame vector and the random measurements taken from the previous wavelet frame vector. The random measurement differences are then processed through an entropy coder to generate the encoded bitstream.

While conventional recovery occurs iteratively in the wavelet domain under spatial constraint (e.g., see Equation 2a), with wavelet-domain measurements, recovery and constraint are in the wavelet-domain, thus reducing decode time according to Equation 9 below:

$$\begin{matrix}min \\ \hat{λ}\end{matrix} {‖ \hat{λ} ‖}_{l 1} subject to y = Φ \hat{ λ} \qquad [ Eqn . 9 ]$$

where λ denotes the coefficients from the wavelet transform. The compression ratio will increase because random measurements of wavelet-domain frame differences have reduced entropy.

For all embodiments disclosed, analyticity of complex wavelet bases or overcomplete complex wavelet frames (or quaternion wavelet bases or overcomplete quaternion wavelet frames) may be exploited during the recovery process. Specifically, the complex wavelet transforms of real-world images are analytic functions with phase: patterns which are predictable from local image structures. Examples of phase patterns may be found in “Signal Processing for Computer Vision,” by G. H. Granlund, H. Knutsson, Kluwer Academic Publishers, 1995. Therefore, the recovery process can be improved by imposing additional constraints on predicted phase patterns.

According to an embodiment, motion information may also be used in the wavelet domain. Normally, it is difficult to exploit motion information in the minimization using Equation 4 because wavelet bases Ψₖ are shift variant, and hence, motion information is garbled. However, over-complete, wavelet frames for Ψₖ are shift-invariant and, therefore, may be used such that motion information is made explicitly available using techniques such as phase-based motion estimation. In other embodiments, over-complete complex wavelet or overcomplete quaternion frames may be used. Because minimization occurs in the decoder, the over-complete wavelet frame does not incur a compression penalty.

In some embodiments, the CS decoder may further be improved by implementing parallelization of the decoding processes. For example, in processes 800 and 1000, the next frame may processed as an estimate of the previous image is calculated at each increasing resolution level.

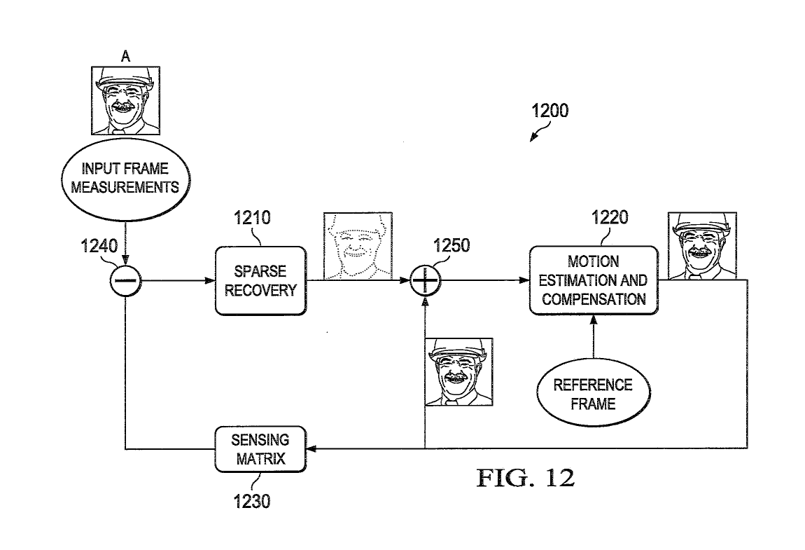

FIG. 12 illustrates a high-level block diagram of a CS decoder according to an embodiment of the present disclosure. The CS decoder 1200 may include a sparse recovery component 1210, a motion estimation & compensation component 1220, a sensing matrix 1230, and any number of subtractors 1240 and adders 1250.

Decoder 1200, or any individual component, may be implemented in one or more field-programmable gate arrays (FPGAs), one or more application-specific integrated circuits (ASICs), as software stored in a memory and executed by a processor or microcontroller. CS decoder may be implemented in a television, monitor, computer display, portable display, or any other image/video decoding device.

The sparse recovery component 1210 solves the sparse recovery problem for an input vector, as discussed with reference to FIGS. 6-10. The motion estimation & compensation component 1220 estimates motion relative to the reference frame (e.g. preceding recontructed frame x_{N}^{prev}) and uses the motion information to compute a motion compensated frame from the reference frame (e.g. mc(x_{N}^{prev}). According to an embodiment, the motion estimation & compensation component 1220 may be broken up into separate components. The sensing matrix component 1230 applies a sensing matrix A to the motion compensated frame to determine the difference vector Δy. Not illustrated in FIG. 12 are a memory, a controller, and an interface to external devices/components. These elements are optional as they be included in the CS decoder 1200 or be external to the CS decoder.

According to an embodiment components 1210-1250 may be integrated into a single component or each component may be further divided into multiple sub-components. Furthermore, one or more of the components may not be included in a decoder according to the embodiment. For example, a decoder that reconstructs video using process 700 may not include the motion estimation & compensation component 1220 and the sensing matrix component 1230.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for encoding a video, comprising:
taking a first plurality of random measurements for a first frame at an encoder;
taking a subsequent plurality of random measurements for each subsequent frame at the encoder, the first plurality of random measurements being greater than each subsequent plurality of random measurements; and
encoding each plurality of random measurements into a bitstream.

2. The method of claim 1, wherein getting the subsequent plurality of random measurements for each subsequent frame comprises:
generating a difference frame by subtracting a previous frame from a current frame; and
getting a subsequent plurality of random measurements from the difference frame.

3. The method of claim 1, wherein getting the subsequent plurality of random measurements for each subsequent frame comprises:
estimating a motion based on a difference between a current frame and a previous frame;
calculating a motion vector based on the estimated motion;
generating a residual frame based on the estimated motion;
performing a Karhunen Loeve Transform (KLT) on the residual frame to determine a KLT rotation;
performing upper/left spatial prediction using blocks of pixels in the residual frame; and
getting the subsequent plurality of random measurements from the difference frame,
wherein the subsequent plurality of random measurements are entropy coded using the motion vector and the KLT rotation to generate the encoded bitstream.

4. The method of claim 1, further comprising:
calculating a difference between a current subsequent plurality of random measurements and a previous subsequent plurality of random measurements,
wherein each subsequent plurality of random measurements are taken using a fixed measurement matrix.

5. The method of claim 4, further comprising performing a wavelet transform on each frame before getting random measurements.

6. An apparatus for encoding video, the apparatus comprising:
a compressive sampling (CS) unit configured to take a first plurality of random measurements for a first frame, and take a subsequent plurality of random measurements for each subsequent frame at the encoder, the first plurality of random measurements being greater than each subsequent plurality of random measurements; and
an entropy coder configured to encode each plurality of random measurements into a bitstream.

7. An apparatus of claim 6, wherein the CS unit, when taking the subsequent plurality of random measurements for each subsequent frame, is further configured to:
generate a difference frame by subtracting a previous frame from a current frame, and
take a subsequent plurality of random measurements from the difference frame.

8. The apparatus of claim 6, wherein the CS unit, when taking the subsequent plurality of random measurements for each subsequent frame, is further configured to:
estimate a motion based on a difference between a current frame and a previous frame,
calculate a motion vector based on the estimated motion,
generate a residual frame based on the estimated motion,
perform a Karhunen Loeve Transform (KLT) on the residual frame to determine a KLT rotation,
perform upper/left spatial prediction using blocks of pixels in the residual frame, and
take the subsequent plurality of random measurements from the difference frame,
wherein the entropy coder is further configured to encode the subsequent plurality of random measurements using the motion vector and the KLT rotation to generate the encoded bitstream.

9. The apparatus of claim 6, wherein the CS unit, when taking the subsequent plurality of random measurements for each subsequent frame, is further configured to:
calculate a difference between a current subsequent plurality of random measurements and a previous subsequent plurality of random measurements, and
take the subsequent plurality of random measurements using a fixed measurement matrix.

10. The apparatus of claim 9, wherein the CS unit is further configured to perform a wavelet transform on each frame before taking random measurements.

11. A method for decoding a video, comprising:
receiving an encoded bitstream at a decoder, the encoded bitstream comprising a current input frame;
perform a sparse recovery on the current input frame to generate an initial version of a currently reconstructed frame based on the current input frame;
generating at least one subsequent version of the currently reconstructed frame based on a last version of the currently reconstructed frame, each subsequent version of the currently reconstructed frame comprising a higher image quality than the last version of the currently reconstructed frame.

12. The method of claim 11, wherein performing sparse recovery comprises using one of complex wavelet bases, overcomplete complex wavelet frames, quaternion wavelet bases, and overcomplete quaternion wavelet frames, such that a constraint on predicted phase patterns is imposed.

13. The method of claim 11, wherein generating each subsequent version of the currently reconstructed frame comprises performing the sparse recovery on the last version of the currently reconstructed frame such that each subsequent version of the currently reconstructed frame supports a higher resolution image than the last version of the currently reconstructed frame.

14. The method of claim 11, wherein generating each subsequent version of the currently reconstructed frame comprises:
determining motion information using the last version of the currently reconstructed frame against a corresponding version of a previously reconstructed frame of a previous input frame;
applying the motion information to a subsequent version of the previously reconstructed frame to generate a motion-compensated frame, the subsequent version of the previously reconstructed frame and the motion-compensated frame supporting a higher resolution than the corresponding version of the previously reconstructed frame; and
performing a sparse recovery on the motion-compensated frame to generate the subsequent version of the currently reconstructed frame.

15. The method of claim 11, wherein generating each subsequent version of the currently reconstructed frame comprises:
determining motion information using the last version of the currently reconstructed frame against a last version of a previously reconstructed frame of a previous input frame;
applying the motion information to the last version of the previously reconstructed frame to generate a motion-compensated frame;
performing a sparse residual recovery on an estimated residual difference between the current input frame and the motion-compensated frame to generate a sparse residual frame; and
adding the sparse residual frame to the motion-compensated frame to determine the subsequent version of the currently reconstructed frame.

16. The method of claim 15, wherein performing the sparse residual recovery on the motion-compensated frame comprises:
applying a sensing matrix to the motion-compensated frame to generate a motion-sensed frame; and
calculating a difference between the current input frame and the motion-sensed frame to determine the estimated residual difference.

17. The method of claim 14, wherein when one of overcomplete complex wavelet frame and overcomplete quaternion wavelet frame is used, determining the motion information comprises performing phase-based motion estimation.

18. The method of claim 11, wherein generating each subsequent version of the currently reconstructed frame comprises:
determining motion information using the last version of the currently reconstructed frame against a corresponding version of a previously reconstructed frame of a previous input frame;
applying the motion information to the corresponding version of the previously reconstructed frame to generate a motion-compensated frame;
performing a sparse residual recovery on the motion-compensated frame to generate a sparse residual frame that supports a resolution of the subsequent version of the currently reconstructed frame;
upsampling the motion-compensated frame to support the resolution of the subsequent version of the currently reconstructed frame; and
adding the sparse residual frame to the upsampled motion-compensated frame to determine the subsequent version of the currently reconstructed frame.

19. An apparatus for decoding video, the apparatus comprising:
a decoder configured to receive an encoded bitstream that includes a current input frame, generate an initial version of a currently reconstructed frame based on the current input frame, and generate at least one subsequent version of the currently reconstructed frame based on a last version of the currently reconstructed frame, the subsequent version of the currently reconstructed frame comprising a higher quality image than the last version of the currently reconstructed frame; and
a controller configured to determine how many subsequent versions of the currently reconstructed frames are to be generated,
wherein the decoder comprises a sparse recovery unit configured to generate the initial version of the currently reconstructed frame by performing a sparse recovery on the current input frame.

20. The apparatus of claim 19, wherein the sparse recovery unit is further configured to perform sparse recovery using one of complex wavelet bases, overcomplete complex wavelet frames, quaternion wavelet bases, and overcomplete quaternion wavelet frames, such that a constraint on predicted phase patterns is imposed.

21. The apparatus of claim 19, wherein the sparse recovery unit is further configured to generate each subsequent version of the currently reconstructed frame by performing a sparse recovery on the last version of the currently reconstructed frame such that each subsequent version of the currently reconstructed frame supports a higher resolution image than the last version of the currently reconstructed frame.

22. The apparatus of claim 19, wherein the decoder, for generating each subsequent version of the currently reconstructed frame, further comprises:
a motion estimator configured to determine motion information using the last version of the currently reconstructed frame against a corresponding version of a previously reconstructed frame of a previous input frame; and
a motion compensator configured to apply the motion information to a subsequent version of the previously reconstructed frame to generate a motion-compensated frame, the subsequent version of the previously reconstructed frame and the motion-compensated frame supporting a higher resolution than the corresponding version of the previously reconstructed frame,
wherein the sparse recovery unit is further configured to perform a sparse recovery on the motion-compensated frame to generate the subsequent version of the currently reconstructed frame.

23. The apparatus of claim 19, wherein the decoder, for generating each subsequent version of the currently reconstructed frame, further comprises:
a motion estimator configured to determine motion information using the last version of the currently reconstructed frame against a last version of a previously reconstructed frame of a previous input frame;
a motion compensator configured to apply the motion information to the last version of the previously reconstructed frame to generate a motion-compensated frame; and
an adder configured to add a sparse residual frame to the motion-compensated frame to determine the subsequent version of the currently reconstructed frame,
wherein the sparse recovery unit is further configured to generate the sparse residual frame by performing a sparse recovery based on an estimated residual difference between the current input frame and the motion-compensated frame.

24. The apparatus of claim 23, wherein the decoder further comprises:
a sensing unit configured to apply a sensing matrix to the motion-compensated frame to generate a motion-sensed frame; and
a subtractor configured to calculate a difference between the current input frame and the motion sensed frame to determine the estimated residual difference.

25. The apparatus of claim 23, wherein the motion estimator is further configured to perform phase-based motion estimation to determine the motion information when one of overcomplete complex wavelet frames and overcomplete quaternion wavelet frames are used.

26. The apparatus of claim 19, wherein the decoder, for generating each subsequent version of the currently reconstructed frame, further comprises:
a motion estimator configured to determine motion information using the last version of the currently reconstructed frame against a corresponding version of a previously reconstructed frame of a previous input frame;
a motion compensator configured to apply the motion information to the corresponding version of the previously reconstructed frame to generate a motion-compensated frame;
an upsampling unit configured to upsample the motion-compensated frame to support the resolution of the subsequent version of the currently reconstructed frame; and
an adder configured to add a sparse residual frame to the upsampled motion-compensated frame to determine the subsequent version of the currently reconstructed frame,
wherein the sparse recovery unit is further configured to generate the sparse residual frame by performing a sparse recovery based on an estimated residual difference between the current input frame and the motion-compensated frame.
